(19) United States
(12) Patent Application Publication
(10) Pub. No.: US 2016/0373504 A1
(43) Pub. Date: Dec. 22, 2016

(54) METHOD FOR SHARING A DIGITAL CONTENT DURING COMMUNICATION

(71) Applicant: ORANGE, Paris (FR)

(72) Inventors: Ghislain Moncomble, Plestin Les Greves (FR); Marc Bailly, Trebeurden (FR)

(21) Appl. No.: 15/174,956

(22) Filed: Jun. 6, 2016

(30) Foreign Application Priority Data
Jun. 9, 2015 (FR) 1555266

(51) Int. Cl. H04L 29/06; H04L 29/08

(52) U.S. Cl. CPC H04L 65/601; H04L 67/141; H04L 67/104

(57) ABSTRACT

The invention relates to a method for sharing a digital content associated with a communication between a first terminal and a recipient terminal, the method comprising the following steps implemented on the first terminal: association (200) of a digital content with at least one navigation command and at least one rendering command, control (202) of transmission of the digital content to the recipient terminal, and, on establishment of the communication, detection (204) of the implementation of at least one navigation command associated with the content, and transmission (205) to the recipient terminal of a rendering command associated with the document. The invention relates also to a device and a terminal implementing the method, and, correspondingly, methods, devices and terminals for restoring a shared content.

### TECHNICAL FIELD

The present invention relates to the field of telecommunications and relates in particular to the sharing of content during a communication.

### PRIOR ART

The mobile phone is now an unavoidable communication means. For a number of years, with the increasing power of the terminals and the emergence of mobile broadband of 3G or 4G type, the usage of the mobile phone has been extended to roaming Internet access. In particular, the terminals of smartphone type offer a multitude of services to their users via the downloading of various applications. These terminals are also equipped with various sensors such as, for example, a camera and a microphone making it possible to capture images or videos. Consequently, the users can at any moment capture images and share them with other users via the broadband connectivity available to them. For example, the users can share such contents via social networks, email or even MMS (Multimedia Messaging Service) messages.

Such terminals also make it possible to receive and view multimedia contents shared by other parties. For example, a smartphone offers the possibility, through various applications, of receiving and viewing emails comprising attachments such as photos or videos, and of viewing online photo albums on various services for sharing between users, and even of receiving MMS messages or shared contents during an instant messaging conversation.

Obviously, the smartphones also make it possible to establish voice communication with other parties.

Thus, the smartphones these days make it possible to exchange any type of information in any place and at any moment and according to different modalities creating novel usages and novel communication modes. Despite everything, these sharings of contents are often done through a non-standard application ecosystem which is not always interoperable. In particular, sharing documents during a voice communication requires the implementation of different communication vectors and sometimes hazardous manipulation procedures.

Initiatives such as the RCS (Rich Communication Suite) standard created at the initiative of the GSM Association (GSMA) and disseminated under the trade name “Joyn” aim to provide a unified and interoperable framework for this new communication mode, called an enriched communication mode. In particular, RCS provides tools for establishing communications to which the users can add contents. For example, RCS defines a standard for the exchange of video or images during a voice communication.

Despite the unification and simplification efforts carried out, these solutions do not overcome the ergonomic problem posed by the simultaneous use of different modalities of communication on a mobile terminal of small size such as a smartphone. In effect, the selection and the sending of one or more documents during a voice communication requires manipulation procedures which, while they are being performed by the sender, interrupt the conversation. Also, the different graphical interface elements that make it possible to select and share a content during a communication occupy a not-inconsiderable space on a screen which is generally of small size.

One of the aims of the invention is to remedy the abovementioned drawbacks of the prior art and/or provide improvements thereto.

### SUMMARY OF THE INVENTION

To this end, the invention relates to a method for sharing a digital content associated with a communication between a first terminal and a recipient terminal, the method being such that it comprises the following steps implemented on the first terminal:
Association of a digital content with at least one navigation command and at least one rendering command,
Command of transmission of the digital content to the recipient terminal, and,
On establishment of the communication,
Detection of the implementation of at least one navigation command associated with the content, and
Transmission to the recipient terminal of a rendering command associated with the document.

A digital content to be shared, for example an image, is associated with navigation and rendering commands before the establishment of a communication then transmitted to the terminal of the recipient. The digital content can be transmitted to the recipient terminal before the establishment of the communication, or during the establishment of the communication. When the communication is established, the first terminal can detect a navigation command activated by a user and trigger the transmission of a rendering command to the recipient terminal. The rendering command is interpreted by the recipient terminal and can consist, for example, of the display of the shared content. The navigation commands are intended to be executed on the first terminal and make it possible, when they are detected, to trigger the sending of a rendering command to the recipient terminal.

With the content being transmitted to the recipient terminal before the establishment of the communication, the latter can be displayed immediately, without latency due to the transmission time, on the recipient terminal on reception of the corresponding rendering command. Also, the rendering command is sent to the recipient terminal on detection of a navigation command associated with the content, the user can trigger the sharing of the content on a simple voice command or a predefined gesture on the screen of the first terminal.

The invention thus significantly improves the ergonomy during a sharing of content and increases the responsiveness thereof compared to the prior art techniques by eliminating, during the communication, the transmission time for the shared contents which provokes a latency prejudicial to the spontaneity of a conversation.

According to a particular embodiment, when the digital content is received by the recipient terminal, the latter can detect the implementation of a navigation command and transmit a rendering command to the first terminal.

In this way, the recipient terminal of a shared content can control its rendering on the first terminal. For example, the recipient of a sharing can implement a navigation command provoking the sending of a rendering command to the first terminal, so as to provoke, on the first terminal, the display of a content received previously.

According to a particular embodiment, the method is such that it further comprises, on completion of the association step, steps of:
storage of the digital content and of the associated navigation and rendering commands,
association of the stored elements with at least one entry of an address book of the terminal.

A content to be shared is stored in association with one or more navigation commands and one or more rendering commands. The storage can be performed on the first terminal or on an online storage device such as a website, a file server or a database for example. The stored data are associated with one or more entries of an address book or even with a group of contacts. For example, a user can associate an image, a voice command and a display command with a particular content of his or her address book. Thus, the content is immediately available for sharing during a subsequent communication with this contact, the rendering command being executed on the terminal of the recipient on detection of the corresponding navigation command.

According to a particular embodiment, the method is such that the transmission command is deferred on detection of a particular communication event.

In this way, the method can trigger the transmission of the content to the recipient terminal according to the phase of a call. For example, a communication event may correspond to the dialling or presentation phase of a communication, to the establishment of a communication following the acceptance of a call by another party or even to the termination of a communication. Thus, a user can, for example, defer the transfer of a content to the moment when a call is accepted by the other party, so that the content cannot be intercepted by the other party without the call being established. The transfer can also be triggered from the dialling phase in order for the content to be immediately available when the other party accepts the communication.

According to a particular embodiment, the method is such that a navigation command corresponds to a voice command detected in the audio stream of the communication.

By allowing the user to associate a voice command such as a keyword with the content to be shared, the invention contributes to improving the ergonomy of the enriched communication services. The user can, in this way, provoke the display or even the recording of the content on the recipient terminal by speaking the keyword during a voice communication for example. The method thus avoids tedious manipulation procedures imposed by the prior art.

According to a particular embodiment, the method is such that a navigation command corresponds to a touch command detected on a screen associated with the terminal.

The user can also associate a touch command with the content. This command can be a particular gesture performed by the displacement of a contact with the screen of the terminal or on a screen associated with the terminal such as, for example, the screen of a connected device such as a connected watch. The rendering of the content on the recipient terminal can thus be provoked by a simple action on the screen of a connected bracelet of the user. According to a particular embodiment, the gesture is a particular movement of the terminal in three dimensions, the movement being able to be captured by virtue of inertial sensors of the terminal or of a worn accessory for example.

According to a particular embodiment, the method is such that a rendering command corresponds to a command to display the digital content.

The rendering command sent to the recipient terminal can be a command aiming to trigger the display of the content on a screen of the recipient terminal or a screen associated with the recipient terminal, such as, for example, the screen of a connected watch associated with the recipient terminal. Thus, the user of the first terminal can, when he or she executes a navigation command, provoke the display of the content on the recipient terminal at the moment which seems most appropriate to him or her. With the content having been transferred previously, the command is executed without latency due to the transmission time of the content.

According to a particular embodiment, the method is such that a rendering command corresponds to a command to store the digital content.

The rendering command sent to the recipient terminal can also be a command aiming to trigger the storage of the content on the recipient terminal. In this way, the user of the first terminal can control the recording of the content on the recipient terminal. For example, the content can be an image stored in a photo album of the recipient terminal or even in a communication log, in association with the entry corresponding to the communication.

According to another aspect and in a manner corresponding to the sharing method, the invention relates to a method for restoring a shared digital content in association with a communication, the method being such that it comprises the following steps:
Reception of at least one digital content, and
On establishment of the communication,
Reception of at least one rendering command associated with the digital content received, and
Execution of the rendering command.

A terminal can thus receive a shared content before a communication and render this content only on reception of an associated rendering command. The rendering command received can for example correspond to a command to display an image or a video in a particular location of the screen or on a remote screen like a connected watch for example, to the playback of a music clip, or even to the opening of a web page. The rendering command can also be a command to change page in the case of a paginated document such as a presentation or text. The rendering command can also be a command to store the content on the terminal making it possible, for example, for the user of a first terminal sending the content to control the recording of an image in a photo album of the terminal.

According to a particular embodiment, the rendering method is such that a rendering command corresponds to a command to display the digital content received.

A recipient terminal can thus display a shared content when it receives an associated rendering command. A sending terminal can thus control the display of a shared content on the terminal of the other party with which it is in communication.

According to a particular embodiment, the rendering method is such that a rendering command corresponds to a command to store the digital content received.

A recipient terminal is thus capable of storing a shared content when it receives an associated rendering command. A sending terminal can thus control the storage of a shared content on the terminal of the other party with which it is in communication. For example, the shared content can be stored in association with an entry of the address book associated with the user sharing the content or even in a photo album of the terminal.

The invention relates also to a device for sharing a digital content associated with a communication to a recipient terminal, the device being such that it comprises:
An interface and a memory capable of implementing and storing an association of a digital content with at least one navigation command and at least one rendering command,
A module for controlling transmission of the digital content to the recipient terminal,
A call management module for establishing a communication,
A module for detecting an implementation of at least one navigation command associated with the content, and
A communication module for the transmission to the recipient terminal of a rendering command associated with the document,
The detection and communication modules being implemented following the establishment of a communication by the call management module.

The invention relates also to a device for restoring a shared digital content in association with a communication, such that it comprises:
A communication module for receiving at least one digital content and at least one rendering command associated with the digital content received,
A call management module for establishing a communication,
A processor capable of executing a rendering command, following the establishment of a communication by the call management module.

The invention relates also to a communication terminal such that it comprises a device for sharing a digital content as described above.

The invention relates also to a communication terminal such that it comprises a device for restoring a shared digital content as described above.

The invention relates also to a communication terminal such that it comprises a device for sharing a digital content and a device for restoring a shared digital content as described above.

The invention relates also to a computer program comprising the instructions for the execution of the method for sharing a digital content and/or the instructions for the execution of the method for restoring a shared digital content, when the program is executed by a processor.

The invention relates also to a processor-readable information medium on which is recorded a computer program comprising the instructions for the execution of the steps of the method for sharing a digital content and/or the instructions for the execution of the method for restoring a shared digital content.

### LIST OF FIGURES

Other features and advantages of the invention will become more clearly apparent on reading the following description of a particular embodiment, given as a simple illustrative and nonlimiting example, and the attached drawings, in which:

FIG. 1 illustrates an architecture suitable for implementing the invention according to a particular embodiment,

FIG. 2 is a simplified representation of the main steps of the sharing method according to a particular embodiment,

FIG. 3 represents, in diagram form, the main steps of the method for restoring a sharing according to a particular embodiment,

FIG. 4 is a simplified illustration of the architecture of a content-sharing device according to a particular embodiment, and

FIG. 5 represents a simplified architecture of a device for restoring a shared content according to a particular embodiment of the invention.

### DETAILED DESCRIPTION OF AN EMBODIMENT

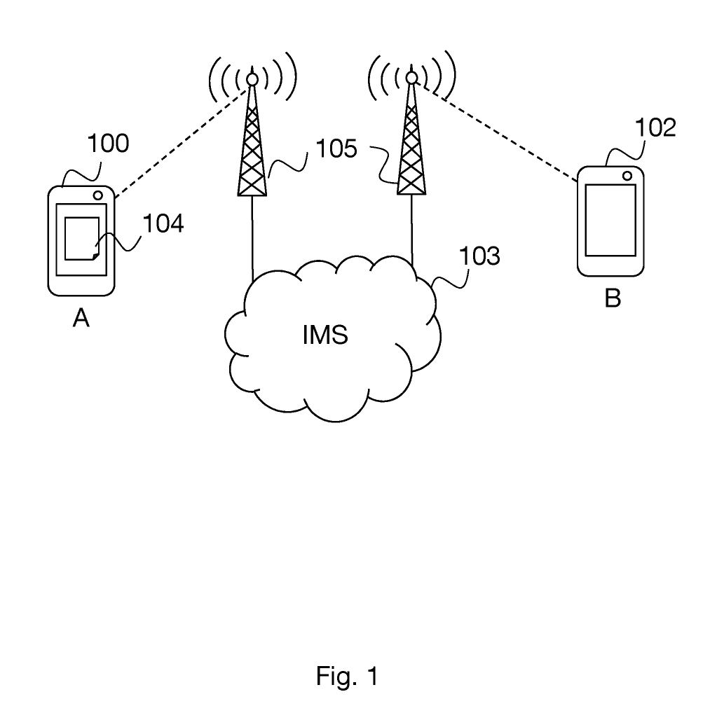

FIG. 1 illustrates an architecture suitable for implementing the invention according to a particular embodiment. Such an architecture comprises, in this example, a first mobile terminal 100 having a content to be shared 104. The terminal 100 is, for example, a smartphone suitable for communicating according to different modalities. The terminal 100 is, in particular, suitable for sending and receiving voice calls and can also connect to a data network such as the IMS network 103 or to the Internet network. The terminal 100 implements the method for sharing a digital content according to a particular embodiment. For that, the terminal comprises a processor and a memory configured to execute instructions for the execution of the method for sharing a digital content.

FIG. 1 also represents a terminal 102. The terminal 102 is, for example, a smartphone configured to communicate according to different modalities and in particular to send and receive voice calls and connect to a data network such as the IMS network 103 or to the Internet network. The terminal 102 implements the method for restoring a sharing according to a particular embodiment. For that, the terminal comprises a processor and a memory configured to execute instructions for the execution of the method for restoring a shared digital content.

The terminals 100 and 102 are equipped with a 3G or 4G network interface enabling them to connect to the IMS network 103, to exchange data and to establish voice communications via the cell network 105.

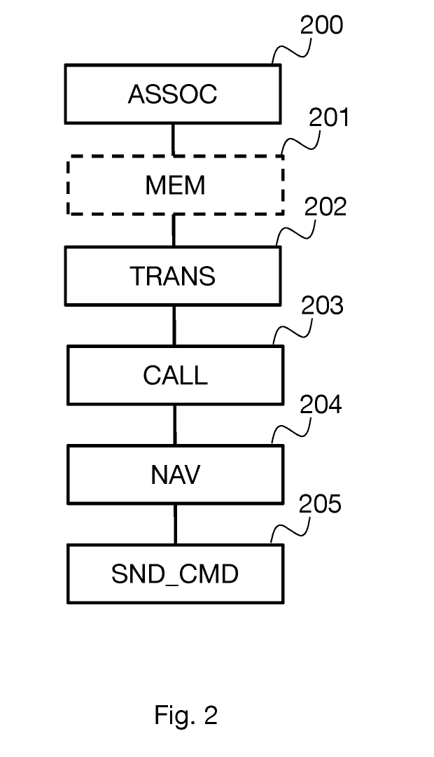

FIG. 2 is a simplified representation of the main steps of the sharing method according to a particular embodiment.

This description of a particular embodiment will take, for example, the case of a user A of the terminal 100 wanting to share the digital content 104 with the user B during a voice communication. The digital content 104 corresponds, for example, to an image that the user A wants to comment on during a communication with B. Obviously, this example is nonlimiting and the invention applies similarly to different types of digital contents, such as, for example, a video or audio clip, documents from a spreadsheet or from a text processing software or even from an Internet site. In the latter case, the digital content concerned in this description can correspond to the URL (Universal Resource Locator) of the website. According to a particular embodiment, the digital content 104 corresponds to a set of digital documents, such as, for example, a list of documents, ordered or not, of the same type or even of different types.

In a first step 200, the digital content to be shared is associated with at least one navigation command and at least one rendering command. For that, the terminal can prompt the user to select one or more documents that he or she wants to share through a suitable graphical interface. The terminal then proposes to the user associating a navigation command with the selected content. The navigation command associated with the content makes it possible to control the sharing of the associated content during communication. According to a particular embodiment, a number of navigation commands are associated with a content. For example, when the content consists of a number of documents, it is possible to associate one navigation command per document. According to another example, in the case of a paginated digital content, a navigation command can be associated with a particular page, with the next page or with the preceding page.

A navigation command can be of different type. For example, it can be a voice command like a keyword spoken by the user, a gesture performed on the touch screen of the terminal, an interaction performed on a worn device associated with the terminal such as, for example, a connected watch or bracelet, a particular movement in three dimensions detected by inertial sensors of accelerometer, gyroscope and/or compass type or even an action on a button of the terminal. The terminal can propose to the user associating a command from a list of preconfigured commands or else recording a new navigation command. For example, the terminal can propose to the user recording a keyword using a microphone of the terminal in order to create a new voice navigation command. The terminal can also propose to the user assigning a physical button of the terminal to the navigation command, such as a sound volume control button for example, or even for example propose associating the masking of the lens of a camera of the terminal by a finger with a navigation command so that the user can implement a navigation command by a simple gesture while keeping the terminal to the ear. According to a particular embodiment, the navigation command corresponds to a communication event, such as, for example, the triggering of a dialling phase, the establishment of a call or even the end of a call. In this way, the method makes it possible to transmit a rendering command associated with a content according to the call establishment phase. It is thus possible to control the display or the storage of an image upon the presentation of a call, during a call or at the end of a call.

The method also makes it possible for the user to associate a rendering command with the content. For that, the terminal proposes, for example, a list of preconfigured rendering commands through a suitable interface and prompts the user to select one or more commands to be associated with the content. A rendering command corresponds to an action associated with the content to be produced on the recipient terminal. For example, it can be an action of displaying an image, of playing back or stopping the playback of an audio or video clip or of movement within the clip, of displaying an office document or of switching to a next or preceding page of this document, or even of storing the document on the recipient terminal, for example in a call log or in a photo library, or of downloading a document available online. A number of rendering commands can be associated with the content. For example, when a digital content comprises a number of documents, a particular rendering command can be associated with each document. According to another example, an image can be associated with a rendering command aiming to provoke a display on the recipient terminal and a rendering command aiming to provoke the storage of the content on the terminal of the recipient.

According to a particular embodiment, the content and the associated navigation and rendering commands are stored in the step 201. The storage is for example performed in a database of the terminal 100 and allows the user to subsequently re-use the content and the associated commands.

The storage can also be performed on a server accessible by a data connection. According to a particular embodiment, the content and the associated commands are stored in association with an entry of an address book associated with the terminal. For example, the content and the associated navigation and rendering commands are stored in the database of an address book of the terminal 100 in association with the entry corresponding to the user B of FIG. 1. Thus, the user A of the terminal 100 can store different types of document that he or she envisages sharing with B during a future communication. In a particular embodiment, these data are stored in association with a group consisting of a set of entries of the address book.

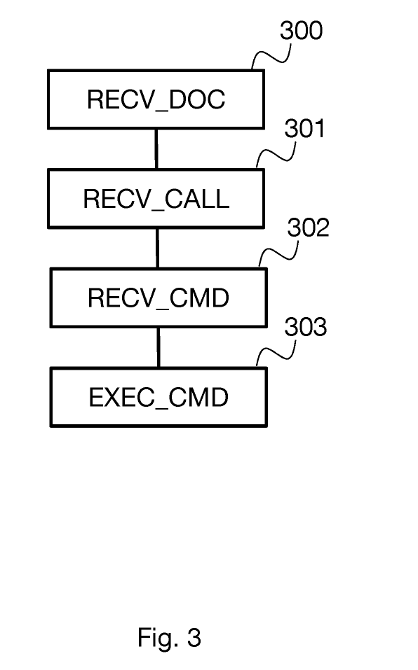

In the step 202, the terminal controls the transmission of the digital content to the recipient terminal. For that, the terminal 100 can establish a connection with the terminal 102 through the IMS network 103 for example and trigger the transfer of the content to the terminal. This transfer of data can be performed using different transmission protocols, such as, for example, by using the http (HyperText Transfer Protocol) or MSRP (Message Session Relay Protocol) protocol or any other suitable data transfer protocol. The document is received by the terminal 102 in a step 300 represented in FIG. 3. The content is then stored temporarily on the terminal 102. According to a particular embodiment, security options on the terminal 102 make it possible for the user to accept or deny the storage or the transfer of the content, or to impose an analysis by antivirus software.

According to a particular embodiment, the transmission step is deferred to the detection of a communication event. For example, the transmission can be triggered as soon as the user A of the terminal 100 dials the call number of B, when the call is presented on the terminal of B or when the communication is established, or even when the communication is terminated. In this way, the user A can be assured that the transfer of the content to B will occur only when particular conditions are met. For example, by deferring the transmission command until the occurrence of an event indicating that the communication is established, the user A can be assured that the content will be available on the terminal of B only when A and B are effectively in communication. According to another example, A can parameterize the step of transmission of a content so that the latter is transmitted only when the communication is terminated in order to transmit, for example, a business card to B.

In the step 203, a voice communication is established between the terminal 100 and the terminal 102. In this example, the communication is initiated by the user A of the terminal 100 to the user B of the terminal 102, but the invention applies equally when the communication is initiated by the user B of the terminal 102. The communication can be a conventional voice call using the GSM network or an IP (Internet Protocol) network such as the IMS network 103. It can also be a video call. The call is accepted in the step 301 by the terminal 102.

Thus, the content shared from the terminal 100 has been transmitted to the terminal 102 via a data connection during the call establishment phase. In the step 204, the terminal 100 detects that at least one navigation command has been implemented. For that, when the navigation command is a voice command, the terminal 100 can analyse the audio signal captured by a microphone of the terminal according to conventional voice recognition techniques, in order to detect therein a keyword spoken by the user and associated with the content in the association step 200. When the command is a touch command, the terminal can detect the movements of a contact on the surface of a touch screen associated with the terminal and analyse the movements of this contact in order to detect a navigation command when the gesture corresponds to the gesture associated with the content. When the navigation command is a particular action performed on a worn device of connected bracelet or connected watch type, the navigation command can be detected by analysing notifications received via a suitable Bluetooth or Wi-Fi interface to communicate with the terminal. The terminal can also analyse the data from inertial sensors associated with the terminal to detect a gesture in three dimensions or interpret actions performed on an input device such as a button. When the implementation of a number of navigation commands is detected by the terminal, the latter can constitute a list of navigation commands which will be interpreted sequentially.

On detection of such a navigation command, the terminal 100 searches for the content and the rendering command associated in the step 200 and transmits this rendering command to the terminal 102 in a step 205. For that, the terminal 100 uses, for example, a data connection such as a Wi-Fi, 3G or 4G connection on which is implemented a data exchange protocol such as MSRP or http for example. The rendering command can then take the form of a message comprising at least one identifier of the content and at least one instruction relating to an action to be performed on this content. The message can also comprise additional parameters such as, for example, a page number or temporal information indicating a playback position of an audio/video clip.

The rendering command is received by the terminal 102 in the step 302 via a network interface of the terminal. From the identifier of the content contained in the message, the terminal 102 searches for the content received in the step 300 and associated with the rendering command.

The terminal 102 executes the rendering command in the step 303. For example, in a non-exhaustive manner, the rendering command can be a command to display the content on a particular area of the screen, a command to store the content on the terminal 102, a command to control the playback of an audio or video clip, or even to change page in a paginated document.

In this way, the user A of the terminal 100 can share and comment on various contents during a communication without that requiring complex manipulation procedures on the terminal. Also, when the contents to be shared are transmitted to the terminal of the other party before the communication is established, content can be presented on the recipient terminal with great responsiveness.

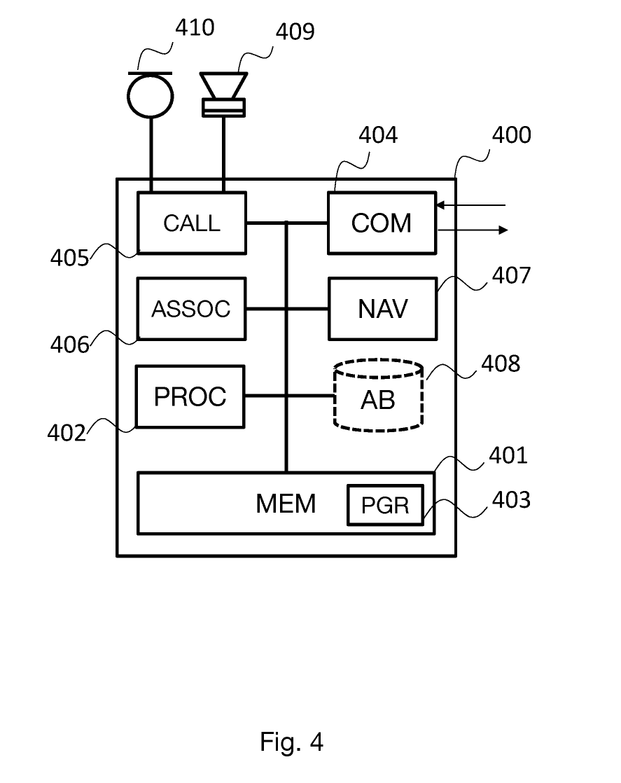

FIG. 4 illustrates a device 400 implementing the method for sharing a digital content associated with a communication, according to a particular embodiment of the invention. The device comprises a storage space 401, for example a memory MEM, a processing unit 402 equipped for example with a processor PROC. The processing unit can be driven by a program 403, for example a computer program PGR, implementing the sharing method as described in the invention with reference to FIGS. 1, 2, and 3, and notably the steps of association of a digital content with at least one navigation command and at least one rendering command, of control of transmission of the digital content to the recipient terminal, and, on the establishment of the communication, of detection of the implementation of at least one navigation command associated with the content, and of transmission to the recipient terminal of a rendering command associated with the document.

On initialization, the instructions of the computer program 403 are, for example, loaded into a RAM (Random Access Memory) memory before being executed by the processor of the processing unit 402. The processor of the processing unit 402 implements the steps of the sharing method according to the instructions of the computer program 403.

For that, the device comprises, in addition to the memory 401, a communication module 404 (COM) suitable for connecting to a network and exchanging data with other devices, and in particular for transmitting a content and a rendering command to a terminal. This communication module can correspond to a Wi-Fi network interface or an interface making it possible to connect to a cellular data network of 3G or 4G type. The device also comprises a call management module 405 (CALL) making it possible for example to establish voice communications with another terminal. This call management module is connected to a microphone 410 and a speaker 409 allowing a user of the terminal to exchange speech with another party. The device comprises an association interface 406 (ASSOC) configured to establish associations between a content and at least one navigation command and at least one rendering command. The association can be performed by storing, for example, a table in the memory 401, the table correlating an identifier of the content, an identifier of a navigation command and an identifier of a rendering command.

In addition to the modules described previously, the device can comprise, according to a particular embodiment, a database 408 (AB) configured to store a content in association with at least one navigation command and at least one rendering command. For example, the database 408 can be an address book of the terminal configured to store a content, a navigation command and a rendering command in association with a particular entry of the address book.

The device also comprises a module for detecting the implementation of a navigation command 407 (NAV). According to a particular embodiment, the microphone 410 is suitable for capturing an audio signal which can be used by the module for detecting a navigation command 407 (NAV) to detect, using a speech recognition algorithm, a keyword spoken by the user of the terminal in order to trigger the sending of a rendering command to a recipient terminal of the sharing. According to a particular embodiment, the detection module 407 is suitable for interpreting signals from inertial sensors with which the device can be provided in order to detect a particular movement of the terminal corresponding to a navigation command. According to a particular embodiment, the detection module 407 is suitable for interpreting movements of a contact on a touch screen associated with the device in order to detect a navigation command by correlation between the observed movements of the contact and a predefined gesture. According to another particular embodiment, the detection module 407 is configured to receive information from another device such as a connected bracelet or a watch and to detect a navigation command performed on this other device.

According to a particular embodiment, the device is incorporated in a mobile terminal of smartphone type or a touch tablet.

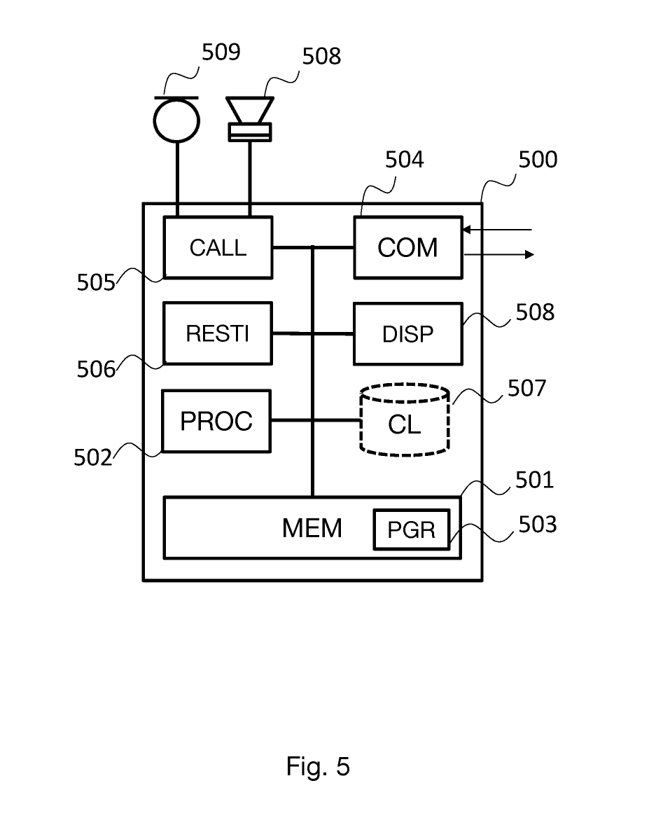

FIG. 5 illustrates a device 500 implementing the method for restoring a shared digital content, according to a particular embodiment of the invention. The device comprises a storage space 501, for example a memory MEM, a processing unit 502 equipped for example with a processor PROC. The processing unit can be driven by a program 503, for example a computer program PGR, implementing the rendering method as described in the invention with reference to FIGS. 1, 2, and 3, and notably the steps of reception of at least one digital content, and, on establishment of the communication, of reception of at least one rendering command associated with the digital content received, and of execution of the rendering command.

On initialization, the instructions of the computer program 503 are for example loaded into a RAM (Random Access Memory) memory before being executed by the processor of the processing unit 502. The processor of the processing unit 502 implements the steps of the rendering method according to the instructions of the computer program 503.

For that, the device comprises, in addition to the memory 501, a communication module 504 (COM) suitable for connecting to a network and exchanging data with other devices, and in particular for receiving a content and a rendering command from a terminal. This communication module can correspond to a Wi-Fi network interface, or an interface making it possible to connect to a cellular data network of 3G or 4G type. The device also comprises a call management module 505 (CALL) making it possible for example to establish voice communications with another terminal. This call management module is connected to a microphone 509 and a speaker 508 making it possible for a user of the terminal to exchange speech with another party. The device comprises a rendering module 506 suitable for interpreting and executing a rendering command received via the communication module 504. According to a particular embodiment, the rendering module 506 is suitable for controlling the display of a content associated with a rendering command received on a screen associated with the device. The rendering module can be, for example, a processor capable of executing a rendering command. According to a particular embodiment, the rendering module 506 is suitable for controlling the storage of a shared content in a memory of the terminal such as, for example, in the memory 501, or in a database such as, for example, a call log database 507 (CL) with which the device can be provided in a particular embodiment.

According to a particular embodiment, the device is incorporated in a mobile terminal of smartphone type or a touch tablet.

1. Method for sharing a digital content associated with a communication between a first terminal and a recipient terminal, characterized in that it comprises the following steps implemented on the first terminal:
Association (200) of a digital content with at least one navigation command and at least one rendering command,
Command (202) of transmission of the digital content to the recipient terminal, and,
On establishment of the communication,
Detection (204) of the implementation of at least one navigation command associated with the content, and
Transmission (205) to the recipient terminal of a rendering command associated with the document.

2. Method according to claim 1, characterized in that it further comprises, on completion of the association step, steps of:
storage of the digital content and of the associated navigation and rendering commands,
association of the stored elements with at least one entry of an address book of the terminal.

3. Method according to claim 1, characterized in that the transmission command is deferred to the detection of a particular communication event.

4. Method according to claim 1, characterized in that a navigation command corresponds to a voice command detected in the audio stream of the communication.

5. Method according to claim 1, characterized in that a navigation command corresponds to a touch command detected on a screen associated with the terminal.

6. Method according to claim 1, characterized in that a rendering command corresponds to a command to display the digital content.

7. Method according to claim 1, characterized in that a rendering command corresponds to a command to store the digital content.

8. Method for restoring a shared digital content in association with a communication, characterized in that it comprises the following steps:
Reception (300) of at least one digital content, and
On establishment of the communication,
Reception (302) of at least one rendering command associated with the digital content received, and
Execution (303) of the rendering command.

9. Method according to claim 8, characterized in that a rendering command corresponds to a command to display the digital content received.

10. Method according to claim 8, characterized in that a rendering command corresponds to a command to store the digital content received.

11. Device for sharing a digital content associated with a communication to a recipient terminal, characterized in that it comprises:
An interface and a memory capable of implementing and storing an association of a digital content with at least one navigation command and at least one rendering command,
A module for controlling transmission of the digital content to the recipient terminal,
A call management module for establishing a communication,
A module for detecting an implementation of at least one navigation command associated with the content, and
A communication module for the transmission to the recipient terminal of a rendering command associated with the document,
The detection and communication modules being implemented following the establishment of a communication by the call management module.

12. Device for restoring a shared digital content in association with a communication, characterized in that it comprises:
A communication module for receiving at least one digital content and at least one rendering command associated with the digital content received,
A call management module for establishing a communication, and
A processor capable of executing a rendering command, following the establishment of a communication by the call management module.

13. Terminal, characterized in that it comprises a device for sharing a digital content associated with a communication to a recipient terminal, characterized in that it comprises:
An interface and a memory capable of implementing and storing an association of a digital content with at least one navigation command and at least one rendering command,
A module for controlling transmission of the digital content to the recipient terminal,
A call management module for establishing a communication,
A module for detecting an implementation of at least one navigation command associated with the content, and
A communication module for the transmission to the recipient terminal of a rendering command associated with the document,
The detection and communication modules being implemented following the establishment of a communication by the call management module; and
a device for restoring a shared digital content in association with a communication, characterized in that it comprises:
A communication module for receiving at least one digital content and at least one rendering command associated with the digital content received,
A call management module for establishing a communication, and
A processor capable of executing a rendering command, following the establishment of a communication by the call management module.

14. Computer program comprising instructions for execution by a processor of a method for sharing a digital content associated with a communication between a first terminal and a recipient terminal, characterized in that it comprises the following steps implemented on the first terminal:
Association (200) of a digital content with at least one navigation command and at least one rendering command,
Command (202) of transmission of the digital content to the recipient terminal, and
On establishment of the communication,
Detection (204) of the implementation of at least one navigation command associated with the content, and
Transmission (205) to the recipient terminal of a rendering command associated with the document; and
instructions for execution by a processor of a method for restoring a shared digital content in association with a communication, characterized in that it comprises the following steps:
Reception (300) of at least one digital content, and
On establishment of the communication,
Reception (302) of at least one rendering command associated with the digital content received, and
Execution (303) of the rendering command.

15. Processor-readable information medium on which is recorded a computer program comprising instructions for execution of a method for sharing a digital content associated with a communication between a first terminal and a recipient terminal, characterized in that it comprises the following steps implemented on the first terminal:
Association (200) of a digital content with at least one navigation command and at least one rendering command,
Command (202) of transmission of the digital content to the recipient terminal, and
On establishment of the communication,
Detection (204) of the implementation of at least one navigation command associated with the content, and
Transmission (205) to the recipient terminal of a rendering command associated with the document; and
instructions for execution of a method for restoring a shared digital content in association with a communication, characterized in that it comprises the following steps:
Reception (300) of at least one digital content, and
On establishment of the communication,
Reception (302) of at least one rendering command associated with the digital content received, and
Execution (303) of the rendering command.
